(19) United States
(12) Patent Application Publication
(10) Pub. No.: US 2016/0149863 A1
(43) Pub. Date: May 26, 2016

(54) METHOD AND SYSTEM FOR MANAGING A HOST-BASED FIREWALL

(71) Applicant: Ditno. Pty Ltd, Sydney, New South Wales (AU)

(72) Inventors: Andrew Peter Walker, Sydney (AU); Glen Francis Messenger, Sydney (AU)

(73) Assignee: Ditno. Pty Ltd, Sydney, New South Wales (AU)

(21) Appl. No.: 14/900,128

(22) PCT Filed: Jun. 25, 2014
(86) PCT No.: PCT/AU2014/050093

§ 371 Date: Dec. 18, 2015

(30) Foreign Application Priority Data
Jun. 25, 2013 (AU) 2013902310

(51) Int. Cl. H04L 29/06; G06F 21/60

(52) U.S. Cl. CPC H04L 63/0263; H04L 63/0209; G06F 21/606

(57) ABSTRACT

Disclosed herein are a system and method for managing a firewall of one or more host computing device associated with a customer, wherein each host computing device including a configurable firewall. In one arrangement, the system includes: a central management suite coupled to a first host computing device via a communications link, said central management suite including: a management portal for receiving instructions from said customer relating to a set of policies, wherein each policy defines a set of firewall rules; a storage device for storing said set of policies in a format inapplicable for configuring the firewall of the first host computing device; and a management policy module for retrieving from said stored set of policies a policy associated with said first host computing device. The system further includes: a first policy translator resident on said first host computing device for receiving said retrieved policy from said central management suite, via said communications link, and for translating said retrieved policy to a format applicable for configuring the firewall of the first host computing device to facilitate implementing a set of firewall rules defined by said retrieved policy.

### TECHNICAL FIELD

The present disclosure relates to methods and systems for managing a host-based firewall.

### BACKGROUND

Computers coupled via a communications network are able to exchange data. A firewall is a security device that acts as a bridge between a computer or computer network and an external communications network, such as the Internet. Information to be exchanged between the computer or computer network and the external network must pass through the firewall. This allows the firewall to regulate incoming and outgoing network traffic, based on a defined rule set. A firewall may be implemented using software or hardware.

A firewall typically analyses incoming and outgoing data packets based on the defined rule set to determine whether or not packets are to be allowed to pass. In this way, the firewall seeks to protect a secure, internal computer or computer network from malicious attacks originating from a communication network.

Some firewalls are implemented as discrete physical components. Other firewalls are integrated into routers that are used to connect one network to another network. Some operating systems incorporate software-based firewalls to help protect a computer on which the operating system is installed. For example, some versions of Microsoft Corporation's “Windows”™ operating system include Windows Filtering Platform (WFP) that provides basic filtering capabilities, based on a user-defined set of rules. Similarly, the Linux™ operating system includes Netfilter, which provides similar capabilities.

None of the existing approaches to implementing firewalls allows a user to define and apply a set of policies remotely from a host computing device on which the firewall operates. Further, none of the existing approaches to implementing firewalls allows a user to capture logging reports from a firewall and subsequently analyse those logging reports at a centralised management device. Further still, none of the existing approaches to implementing host-based firewalls using local capabilities allows a user to centrally manage a plurality of host computing devices and analyse logs from those devices.

Thus, a need exists to provide an improved system and method for managing firewalls on host computer devices.

### SUMMARY

The present disclosure relates to a method and system for use in centralised management of a firewall on a host computing device.

In a first aspect, the present disclosure provides a system for managing a firewall of one or more host computing devices associated with a customer, each host computing device including a configurable firewall, said system including:
a central management suite coupled to a first host computing device via a communications link, said central management suite including:
   a management portal for receiving instructions from said customer relating to a set of policies, wherein each policy defines a set of firewall rules;
   a storage device for storing said set of policies in a format inapplicable for configuring the firewall of the first host computing device; and
   a management policy module for retrieving from said stored set of policies a policy associated with said first host computing device; and
a first policy translator resident on said first host computing device for receiving said retrieved policy from said central management suite, via said communications link, and for translating said retrieved policy to a format applicable for configuring the firewall of the first host computing device to facilitate implementing a set of firewall rules defined by said retrieved policy.

In a second aspect, the present disclosure provides a method for managing a firewall of one or more host computing devices associated with a customer, said method including the steps of:
installing a first policy translator on a first host computing device including a first configurable firewall, said first policy translator being adapted to translate a firewall policy in a format inapplicable for configuring the first firewall to a format applicable for configuring the first firewall;
registering said first host computing device with a central management suite, said central management suite including a management portal, a management policy module, and a storage device;
defining a set of policies, each policy in said set of policies defining a set of firewall rules;
assigning a first policy from said set of policies to said first host computing device; and
transmitting said first policy from said central management suite to said first policy translator to thereby configure the first firewall to facilitate implementing the set of firewall rules defined by said first policy.

In a third aspect, the present disclosure provides a system for managing a firewall of one or more host computing devices associated with a customer, said system including:
a first policy translator resident on a first host computing device coupled to a central management suite, via said communications link, and including a first configurable firewall, the first policy translator adapted for receiving a policy retrieved from the central management suite and for translating said retrieved policy to a format applicable for configuring the first firewall of the first host computing device to facilitate implementing a set of firewall rules defined by said retrieved policy; and
a first host logging module resident on said first host computing device, said first host logging module adapted to record logging information relating to said first host computing device in accordance with said retrieved policy,
wherein the central management suite includes:
   a management portal for receiving instructions from said customer relating to a set of policies, wherein each policy defines a set of firewall rules;
   a storage device for storing said set of policies in a format inapplicable for configuring the first firewall of the first host computing device; and
   a management policy module for retrieving from said stored set of policies a policy associated with said first host computing device.

In a fourth aspect, the present disclosure provides a central management suite for managing a firewall of one or more host computing devices associated with a customer, said central management suite coupled to a first host computing device including a first configurable firewall via a communications link, said central management suite including:
a management portal for receiving instructions from said customer relating to a set of policies, wherein each policy defines a set of firewall rules;
a storage device for storing said set of policies in a format inapplicable for configuring the first firewall of the first host computing device; and
a management policy module for retrieving from said stored set of policies a policy associated with said first host computing device,
wherein said first host computing device includes a first policy translator for receiving said retrieved policy from said central management suite, via said communications link, and for translating said retrieved policy to a format applicable for configuring the first firewall of the first host computing device to facilitate implementing a set of firewall rules defined by said retrieved policy.

Also described herein is a system for managing a firewall of a first host computing device associated with a customer, said first host computing device including a programmable firewall, said system comprising: a central management suite coupled to said first host computing device via a communications link, said central management suite including: a management portal for receiving instructions from said customer relating to a set of policies, wherein each policy defines a set of firewall rules; a storage device for storing said set of policies; and a management policy module for retrieving from said stored set of policies a policy associated with said first host computing device; a host policy module resident on said first host computing device for receiving said retrieved policy from said management policy module, via said communications link; and a driver resident on said first host computing device, said driver adapted to translate said retrieved policy to a format suitable for an application programming interface of the firewall to implement a set of firewall rules defined by said retrieved policy.

Also described herein is a method for managing a first firewall of a first host computing device associated with a customer, said first host computing device including a first programmable firewall implemented by a first native enforcement capability, said method comprising the steps of: installing a first host policy module and a first driver on said first host computing device, said first driver being adapted to translate instructions to a format suitable for an application programming interface of said first native enforcement capability; registering said first host computing device with a central management suite, said central management suite including a management portal, a management policy module, and a storage device; defining a set of policies, each policy in said set of policies defining a set of firewall rules; assigning a first policy from said set of policies to said first host computing device; transmitting said first policy from said central management suite to said first host policy module; said first host policy module forwarding said first policy to said first driver for translation to a format suitable for said first native enforcement capability; and said first native enforcement capability implementing said first firewall based on the set of firewall rules defined by said first policy.

Also described herein is an apparatus for implementing any one of the aforementioned methods.

Also described herein is a computer program product including a computer readable medium having recorded thereon a computer program for implementing any one of the methods described above.

Other aspects of the present disclosure are also provided.

### BRIEF DESCRIPTION OF THE DRAWINGS

One or more embodiments of the present disclosure will now be described by way of specific example(s) with reference to the accompanying drawings, in which:

FIG. 1a is a schematic block diagram representation of a host computing device having an installed operating system and a firewall;

FIG. 1b is a schematic block diagram representation of an embodiment of the host computing device of FIG. 1a, wherein the operating system is a Windows operating system and the firewall is implemented using the Windows Filtering Platform (WFP);

FIG. 1c is a schematic block diagram representation of an embodiment of the host computing device of FIG. 1a, wherein the operating system is a Linux operating system and the firewall is implemented using Netfilter;

FIG. 2a is a schematic block diagram representation of a first example of a system that includes a host computing device and a central management suite;

FIG. 2b is a schematic block diagram representation of a second example of a system that includes a host computing device and a central management suite;

FIG. 2c is a schematic block diagram representation of a third example of a system that includes a host computing device and a central management suite;

FIG. 3a is a schematic block diagram representation of an example of a system incorporating multiple host computing devices;

FIG. 3b is a schematic block diagram representation of another example of a system incorporating multiple host computing devices;

FIG. 4 is a flow diagram illustrating a method of remotely managing a firewall on a host computing device;

FIG. 5 is a schematic block diagram representation illustrating a customer registration process;

FIG. 6 is a schematic block diagram representation illustrating registration of a host computing device;

FIG. 7 is a schematic block diagram representation illustrating definition of objects, rules, and policies for use in a firewall of a computing system;

FIG. 8 is a schematic block diagram representation illustrating definition of groups and related associations;

FIG. 9 is a schematic block diagram representation illustrating asset polling and association;

FIG. 10 is a schematic block diagram representation illustrating logging performed in relation to a host computing device;

FIGS. 11a and 11b are schematic block diagram representations illustrating functional components of a computing system with a central management suite for remotely managing a firewall of a host computing device;

FIG. 12 is a schematic representation of a system on which one or more embodiments of the present disclosure may be practised;

FIG. 13 is a schematic block diagram representation of a system that includes a general purpose computer on which one or more embodiments of the present disclosure may be practised;

FIG. 14 is a flow diagram illustrating a method of remotely managing a firewall on a host computing device;

FIG. 15 is a schematic representation of a rules interface;

FIG. 16 is a screenshot of a policies interface;

FIG. 17 is a schematic representation of a groups interface;

FIGS. 18a-c are schematic representations of a rule editing interface;

FIG. 19 is a schematic representation of a policy editing interface; and

FIGS. 20a-b are schematic representations of a group editing interface.

### DETAILED DESCRIPTION

Method steps or features in the accompanying drawings that have the same reference numerals are to be considered to have the same function(s) or operation(s), unless the contrary intention is expressed or implied.

The present disclosure provides a method and system that allow centralised management of a firewall on one or more host computing devices. In one arrangement, the method and system utilise a driver installed on a host computing device to facilitate control and management of a firewall on that computing device. The driver is adapted to communicate with at least one application programming interface of the kernel of the operating system of the host computing device and one or more local services resident on the host computing device to communicate with a centralised management suite. The host computing device (or “asset”) may be, for example, a personal computer, physical computer server, virtual computer server, laptop computer, or tablet computing device.

The firewall implemented on each host computing device may have different features or functionalities, depending on the operating system executing on the host computing system and the native enforcement capability. The native enforcement capability refers to the localised method of firewalling provided on each particular host computing device. For the Linux operating system the native enforcement capability is implemented using Netfilter and for the Windows operating system the native enforcement capability is implemented using WFP. It will be appreciated by a person skilled in the relevant art that the system and method of the present disclosure are not restricted to Netfilter and WFP implementations and can be applied to any native enforcement capability used to implement firewalling of a host computing device.

In this specification, the “firewall” of a device refers generally to firewalling rules to control a flow of information to and from the device. Although the description herein provides specific examples of a firewall as the native enforcement capability of a kernel, references to a “firewall” are not necessarily limited to specific hardware, programs, or modules. The term “firewall” may refer generally to the capability of a device to facilitate network security.

The method and system also utilise a central management suite to communicate with the host computing device and thereby transmit information to the driver. Such information may include, for example, policies to be applied by the firewall. The method and system transmit the information from the central management suite to the driver installed on the host computing device. The driver receives the transmitted information and configures the firewall to implement the required policies. The central management suite may be implemented as a set of applications or functional modules executing on one or more computing devices. The computing devices may be located in an integral device or as discrete computing devices.

In one arrangement, the central management suite communicates with the host computing device to enable logging capabilities relating to a firewall of the host computing device. The logging capabilities are defined by rulesets and policies configured from the central management suite. The logging capabilities allow an administrator to use the central management suite to establish rules or policies relating to logging activities to be performed by a host logging module on the host computing device. The host logging module transmits resultant logs to the central management suite for storage and later analysis via a proxy logging service, also referred to herein as a management logging module. Analysis of the logging reports may be used, for example, to determine one or more performance attributes of the firewall.

In another arrangement, the method and system include heartbeat functionality between the central management suite and one or more host computing devices. The heartbeat functionality provides the central management suite with an indication of an active or inactive state of each host computing device and may be used, for example, for maintenance and for determining billing arrangements relating to managing firewall functionality of the host computing devices.

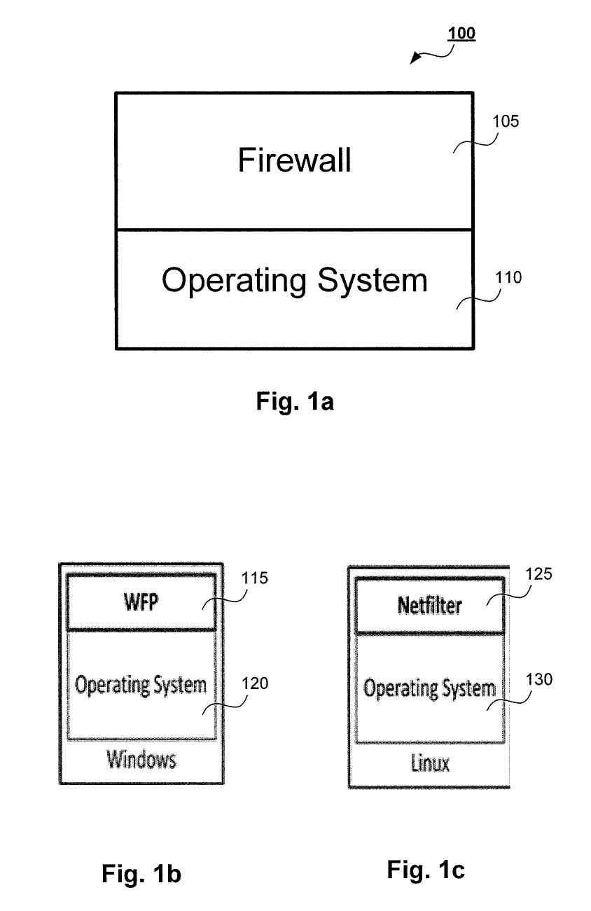

FIG. 1a is a schematic block diagram representation of a host computing device 100 having an installed operating system 110 and a firewall 105. The firewall utilises a set of rules to control a flow of information to and from the computing device 100. FIG. 1b is a schematic block diagram representation of an embodiment of the host computing device 100, wherein the operating system is a Windows operating system 120 and the firewall is implemented using the Windows Filtering Platform (WFP). WFP acts as a kernel application programming interface (API) for controlling one or more firewall parameters. FIG. 1c is a schematic block diagram representation of an embodiment of the host computing device 100, wherein the operating system is a Linux operating system 130 and the firewall is implemented using Netfilter. Netfilter acts as a kernel API for controlling one or more firewall parameters.

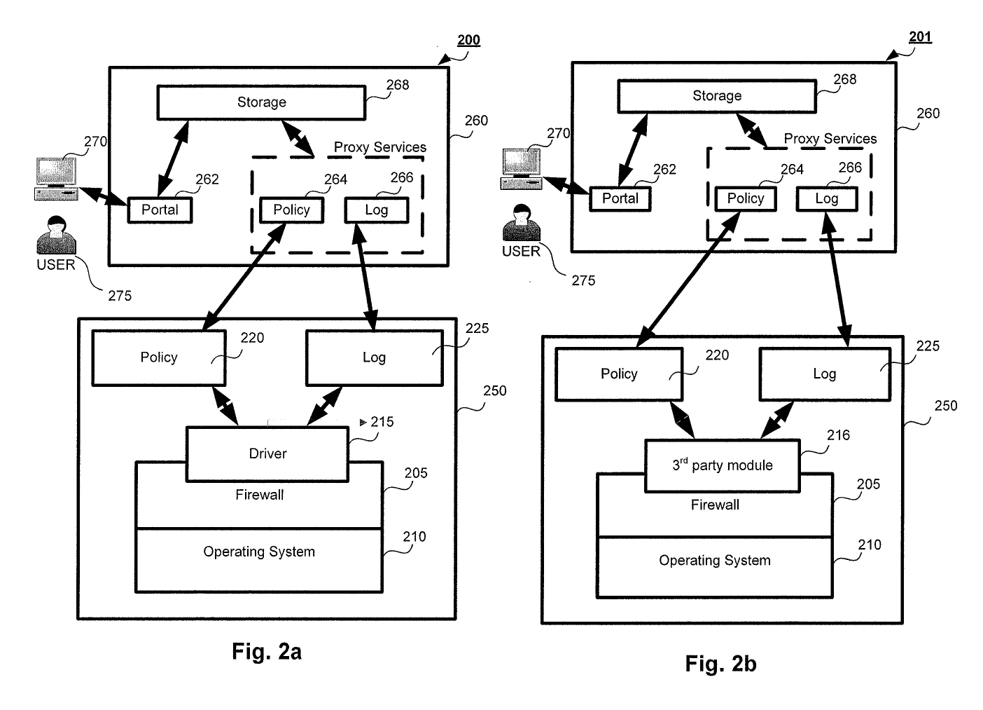

FIG. 2a is a schematic block diagram representation of a first example of system 200 that includes a host computing device 250 and a central management suite 260. The host computing device 250 includes an operating system 210 and a firewall 205. The operating system 210 and firewall 205 may be implemented, for example, using Windows and WFP or Linux and Netfilter, or any other combination of operating system and native enforcement capability. In this example, the host computing device 250 also includes a driver 215 installed to communicate directly with the firewall 205. The driver 215 exists within kernel space, being a portion of the memory of the host computing device in which the kernel of the operating system 210 executes. The driver 215 is adapted to communicate with the native enforcement capability providing the firewall 205.

The host computing device 250 further includes a host policy module 220 and a host logging module 225, each of which communicates with the driver 215. The host policy module 220 and host logging module 225 exist in user space, being a portion of the memory of the host computing device in which user processes execute. The host policy module 220 performs retrieval of policies from the central management suite 260 and forwards the retrieved policies to the driver 215. The driver 215 translates a received policy for presentation via a kernel API to configure the firewall 205 in accordance with the retrieved policy.

In the example of FIG. 2a, the driver 215 is a policy translator that translates retrieved firewall policies into a format compatible with the firewall 205. To manage the firewalls of one or more host computing devices, especially where different firewalls are operated by different operating systems, there may be such a policy translator resident on each of the one or more of the host computing devices. The policy translator is adapted to translate firewall policies received (for example) from the central management suite 260 (and which may not be natively compatible with a given firewall 205) into a format compatible with the firewall 205. The policy translator, which is specific to the operating system, ensures readability of the firewall policy by the one of more host computing devices.

In another example, such as that shown in FIG. 2b, the policy translator is a host policy module. In this example, the host policy module is adapted to translate the retrieved policies and communicate the retrieved policies to an application module 216 resident on the host computing device 250. The application module 216 may be a third-party module which is adapted to configure the firewall. In this example, the host policy module 220 and the host logging module 225 are configured to communicate directly with the application module 216 to facilitate implementation of firewall policies. The application module 216 may be, for instance, a web application firewall, an email server security enforcement module, or an anti-virus controller. In another instance, the application module 216 may be legacy software installed on the host device some time before the host policy module 220 and the host logging module 225 are installed on the host device 250. In this example, therefore, the host policy module 220 and the host logging module 225 are adapted to provide compatibility with third party software that are capable of configuring the firewall. While in the previous example, the driver 215 is adapted to translate a firewall policy for configuring the firewall, in this example, it is the host policy module that translates a firewall policy to thereby enable the application module 216 to configure the firewall. The description hereinafter regarding the driver is therefore equally applicable to the host policy module in this example.

In another example, such as that shown in FIG. 2c, the policy translator is again a host policy module. In this example, the host policy module is adapted to translate the retrieved policies and communicate the translated policies directly to a native component of the operating system, such that the firewall may be configured by the native component. While in a previous example, the driver 215 is adapted to translate a firewall policy for configuring the firewall, in this example, it is the host policy module that translates a firewall policy to thereby enable the native component to configure the firewall. The description hereinafter regarding the driver is therefore equally applicable to the host policy module in this example.

In the examples of FIGS. 2a-2c, the central management suite 260 includes a storage module 268, a management portal 262, a management policy module 264, and a management logging module 266, which communicate with each other using one or more buses or other communication links (not shown). The management portal 262 manages communication with a remote computing device 270 utilised by a user 275. The central management suite 260 may be implemented using a single computing device, multiple computing devices in a single location, or multiple computing devices in different locations.

The central management suite 260 is coupled to the host computing device 250 using a communications link, which may be wired, wireless, or a combination thereof. The communications link may be a single link or a network, such as the Internet. The management policy module 264 communicates with the host policy module 220 and the management logging module 266 communicates with the host logging module 225. In one arrangement, the management policy module 264 communicates with the host policy module 220 and the management logging module 266 communicates with the host logging module 225.

A user wanting to configure or modify a policy of the host computing device 250 utilises the computing device 270 to communicate with the management portal 262 and create or modify one or more policies. The management portal 262 stores the new or modified policies in the storage module 268 for later retrieval by the management policy module 264. The management policy module 264 reads policies from the storage module 268 and transmits the policies to the host policy module 220, which in turn interacts with the driver 215 to apply the policies to the firewall 205. The driver 215 may be configured to apply policies to the firewall/NEC in a number of ways.

For example, the driver 215 may apply policies to the firewall by configuring the firewall 205 to implement the policies itself: i.e. the firewall 205 makes decisions as to whether to allow/deny and log/not log packets itself without further reference to the driver 215 (excepting when new policies are received). To achieve this the driver 215 provides the policies to the firewall 205 by translating the policies into a native structure/format suitable for data input for the operating system 210 and parses the translated policies to the relevant kernel API of the firewall 205. For example, if the operating system 210 is Linux and the firewall is implemented using Netfilter, the driver 215 translates the policies to a format suitable for input to Netfilter to configure the firewall 205. On receipt of incoming packets, the firewall 205 applies the policies received from the driver to make a decision (allow/deny and log/not log).

In an alternative arrangement, the driver 215 may apply policies to the firewall by configuring the firewall 205 to inform the driver 215 of all incoming packets and act on decisions made by the driver: i.e. the driver 205 makes decisions as to whether to allow/deny and log/not log packets. In this case the driver 215 configures the firewall 205 to inform the driver of all incoming data packets. The firewall 205 may inform the driver 215 of incoming packets by, for example, forwarding relevant header information of incoming packets to the driver or forwarding the entire packet (including the packet payload) to the driver 215. On receiving packet information the driver makes the relevant decisions according to the policies—i.e. for the packet to be allowed or denied (and whether or not to log the packet)—and instructs the firewall to allow or deny the packet accordingly. The firewall 205 receives the instruction from the driver 215 and allows or denies the packet accordingly.

In a further alternative arrangement, the driver 215 may apply policies to the firewall by configuring the firewall 205 to refer certain packets to the driver to make a decision on and to make decision on other packets itself. In this case the driver configures the firewall to inform the driver 215 only of incoming data packets meeting certain criteria (e.g. based on source IP address, destination IP address or other criteria). When the firewall 205 receives an incoming packet which meets the criteria it informs the driver 215 of the packet, the driver 205 makes a decision—allow/deny and log/not log—and instructs the firewall 215 to allow or deny the packet accordingly. Conversely, when the firewall 205 receives a packet that does not meet the criteria the firewall 205 itself makes the decision to allow/deny and log/not log the packet (according to its own configured policies).

During operation of the host computing device 250, the driver 215 transmits logging data to the host logging module 225, which in turn communicates the logging data to the management logging module 266. In arrangements where the driver 215 is configured to determine the appropriate action in respect of an incoming packet, logging data are generated by the driver 215 itself based on the determination. In arrangements where the firewall 205 is configured to determine the appropriate action, the determination made by the firewall 215 includes a determination as to whether or not to log information regarding the packet and action taken. In this case the firewall 215 communicates the logging data to the driver 205 (which then communicates the logging data to the host logging module 225) or directly to the host logging module 225. The management logging module 266 then writes the logs to the storage module 268.

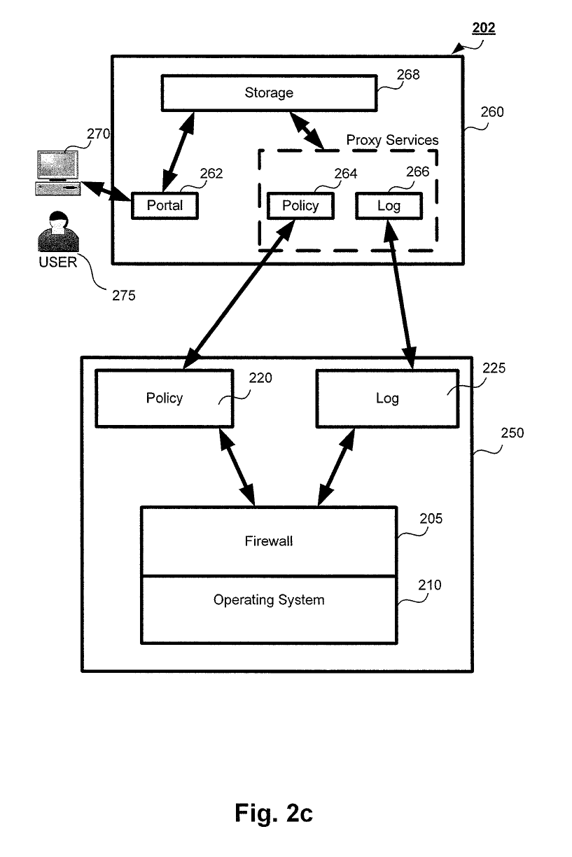

FIG. 3a is a schematic block diagram representation of an example of a system 300 incorporating multiple host computing devices. The system 300 includes a central management suite 360 that includes a storage module 368, a management portal 362, a management policy module 364, and a management logging module 366. The system 300 further includes a first host computing device 310 and a second host computing device 330.

In the example of FIG. 3a, the first host computing device 310 is a personal desktop computer running the Windows operating system 312 with an associated WFP firewall 314. The first host computing device also has an installed first driver 316, a first host policy module 318, and a first host logging module 320.

The second host computing device 330 is a computer server running the Linux operating system 332 with an associated Netfilter firewall 334. The second host computing device also has an installed second driver 336, a second host policy module 338, and a second host logging module 340.

The central management suite 360 provides functionality that allows a user to access and remotely control the firewall settings of multiple host computing devices 310, 330, despite the first and second host computing devices 310, 330 executing different operating systems and firewalls. Further, the central management suite 360 allows a user to group the first host computing device 310 and the second computing device and then apply a single policy to the group. This provides an efficient way for the user to apply and manage firewall policies from the central management suite 360.

FIG. 3b is a schematic block diagram representation of another example of a system 301 including a central management suite 360 of FIG. 3a and multiple host computing devices 380, 382 and 384 as illustrated in, respectively, FIGS. 2a, 2b and 2c.

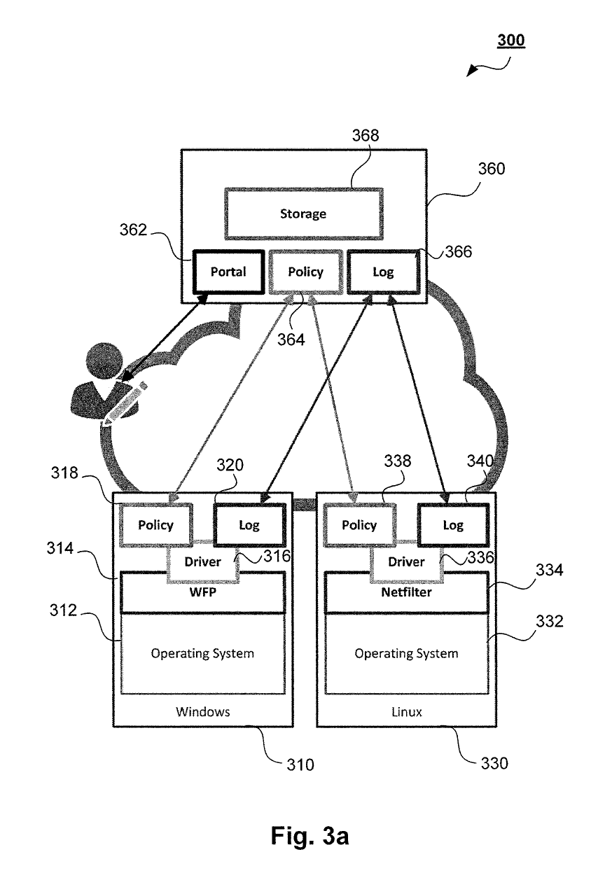

FIG. 4 is a flow diagram illustrating a method 400 of remotely managing a firewall on a host computing device. The method 400 begins at a Start step 405 and proceeds to step 410, which installs security software onto a host computing device. The security software includes the driver 215, host policy module 220, and host logging module 225 of FIG. 2. Control proceeds to step 415, in which the installed security software registers the host computing device with a central policy service, such as the management policy module 264 of the central management suite 260 of FIG. 2.

Control passes from step 415 to step 420, in which an administrator of the host computing device utilises a computing device to log in to the management portal of the central management suite and construct a set of firewall policies. Each host computing device is associated with a customer, which may be an individual, a corporate entity, or other organisation. An administrator is a user, uniquely associated with a particular customer, who is authorised to perform administrative functions relating to one or more host computing devices associated with that customer.

Prior to any other interactions with the central management suite, it is necessary for the customer to register with the central management suite. During registration, the central management suite creates a customer profile for the customer and assigns a customer identifier and customer password. The customer identifier is used to differentiate between customers. The customer identifier is also used to identify host computing devices associated with the respective customers and to regulate interaction with the management portal from users and host computing devices.

In one implementation, the storage module 268 of the central management suite 260 stores a user profile for each registered customer, each user profile having a set of attributes. The set of attributes may include, for example, customer identifier, customer password, contact details, billing details, and the like. The set of attributes may also include a set host computing devices associated with the customer and a set of policies. In one implementation, each host computing device is assigned to a group and the customer is then able to assign a policy from the set of policies to one or more groups.

An administrator associated with a registered customer uses the relevant customer identifier and customer password to log in to the management portal of the central management suite and gain access to one or more sets of firewall policies associated with one or more host computing devices associated with that customer.

A customer registers one or more host computing devices (assets) with the central management suite. The customer is able to classify each registered host computing device associated with that customer into one or more groups. Each group of host computing devices is associated with a customer policy. This allows a customer to configure and apply a customer policy to a group of host computing devices. Each customer policy is a set of firewall policies to be applied to the relevant group of host computing devices.

A registered host computing device that has not been classified into a group is in an “unassociated” state and has no firewall policy to enforce. A registered host computing device that has been classified into a group of host computing devices, wherein the group does not have a defined customer policy associated with that group, is in an “associated” state but has no firewall policy to enforce.

Returning to FIG. 4, in a next step 425 the administrator applies the set of firewall policies constructed in step 420 to the firewall of the host computing device. In practice, the administrator submits the set of firewall policies to the management portal 262 for implementation by the central management suite 260 on one or more host computing devices.

In step 430, the host policy module 220 installed on the firewall of the host computing device polls the management policy module 264 of the central management suite at regular periodic intervals to determine whether a new set of firewall policies has been applied.

In step 435, the management policy module 264 receives a request from the host policy module 220 installed on the host computing device, retrieves any applied set of firewall policies from the storage module 268 and returns the applied set of firewall policies to the host policy module 264 installed on the host computing device. Control passes to step 440, in which the host computing device, using the host policy module 220 and the driver 215, interprets and applies the set of firewall policies. That is, the host policy module 220 receives an applied set of firewall policies from the management policy module 264 and passes the set of firewall policies to the driver 215, which in turn applies the policies as described above.

In some examples, the policies define rules based on information contained in the network layer (i.e. layer 3) header and/or the transport layer (i.e. layer 4) header of the relevant data packet. In these examples, the header information may be extracted by the kernel and forwarded to the driver 215 or the firewall 205 for use in determining an appropriate action. For instance, the extracted information may be the transport protocol header information (e.g. the Transmission Control Protocol (TCP), the network protocol (e.g. Internet Protocol (IP)) of the relevant data packet.

In step 445, the host logging module 225 on the host computing device 250 transmits firewall logs to the management logging module 266 of the central management suite. Control then passes to step 450, in which the management logging module 266 stores the received firewall logs in the storage module 268, which may be implemented as one or more recordable storage devices. The stored firewall logs are then available to be viewed or graphed at a later time, such as by a customer accessing the central management suite via the management portal 262. In one arrangement, the administrator logging in to the management portal 262 is able to retrieve and view firewall logs. In one implementation, the central management suite provides an analysis module to analyse the firewall logs and produce reports and charts derived from the firewall logs. Control passes to an End step 455 and the method 400 terminates.

Depending on the implementation, a set of firewall policies constructed by the administrator in step 425 may be applied to multiple host computing devices in step 425, in a manner similar to that described above with reference to the multiple host computing devices 310, 330 of FIG. 3.

The method 400 uses a centralised management suite to enable centralised administration of host firewall policies, centralised deployment of firewall policies across numerous operating systems, and centralised viewing and graphing of logs generated by the firewalls.

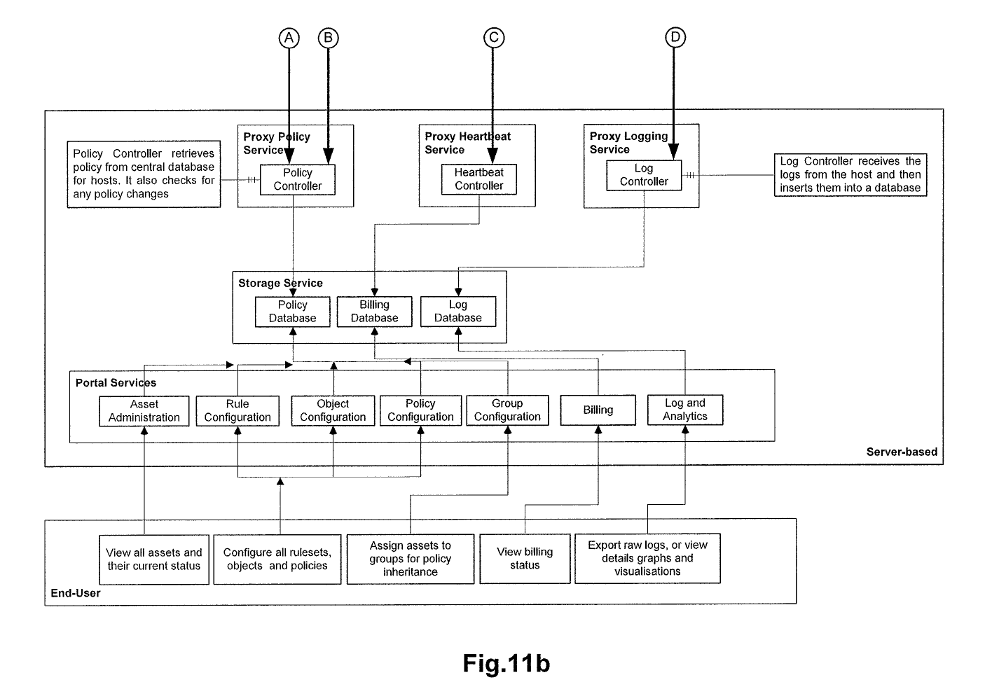

FIG. 14 is a flow diagram illustrating a method 1400 of remotely managing a firewall on a host computing device. The method 1400 is similar to method 400 of FIG. 4, but provides additional functionality relating to association of a host computing device to a group and application of a policy to a group of host computing devices. The method 1400 begins at a Start step 1405 and proceeds to step 1410, which installs security software onto a host computing device. The security software includes the driver 215, host policy module 220, and host logging module 225 of FIG. 2. Control proceeds to step 1415, in which the installed security software registers the host computing device with a central policy service, such as the management policy module 264 of the central management suite 260 of FIG. 2.

Control passes from step 1415 to step 1420, in which an administrator of the host computing device utilises a computing device to log in to the management portal of the central management suite and construct a set of firewall policies. Each host computing device is associated with a customer, which may be an individual, a corporate entity, or other organisation. An administrator is a user, uniquely associated with a particular customer, who is authorised to perform administrative functions relating to one or more host computing devices associated with that customer.

In a next step 1425, the administrator creates a new group for asset association and policy binding. Once created, the group can be populated by associating one or more host computing devices (assets) with the group. In step 1430, the administrator associates one or more policies from the set of policies created in step 1420 to the group created in step 1425. In step 1435, the administrator associates the host computing device registered in step 1415 with the group created in step 1425.

In a next step 1440, the host policy module 220 polls the management policy module for any group associations relating to the host computing device. In step 1445, the host policy module 220 polls for any relevant policies associated with the group associated with the host computing device, as determined in step 1440.

In step 1450, the management policy module 264 retrieves from the storage module 268 any relevant policies applied to the group with which the host computing device 250 is associated. The management policy module 264 returns the retrieved policies to the host policy module 220. In step 1455, the host policy module 220 receives the retrieved policies, forwards the policies to the driver 215 for translation and application via the kernel API to configure the firewall. In step 1460, the host logging module 225 transmits logs derived from the firewall 205 to the management logging module 266. The content and format of the logs is optionally controlled by one or more parameters configured by the administrator via the management portal 262. The logging module 266 may be further adapted to translate the logging information in a first data format or structure, for example as outputted from the driver or the firewall of the host computing device, into logging information in a second data format or structure, which is for example for distribution to and storage at the central management suite. The log translation may be based on and specific to any one or more of the host computing device, the operating system and/or the native enforcement capability. Localised log translation (i.e. log translation at each of host computing devices) may be useful if different host computing devices generate logs in different logging data formats or structures to ensure readability of logging information generated by different platforms. For example, logging information generated by a host computing device operated by one operating system may indicate the time of a logged event in a 24-hour format, whereas logging information generated by a host computing device operated by another operating system may indicate the time of a logged event in AM/PM format. If the central management suite 260 is configured to recognise only a 24-hour format, it may erroneously represent afternoon logged events in AM/PM format (for example, 3:33 pm) as occurring in the period beginning at midnight and ending at noon (using the previous example, 03:33). With log translation specific to the host computing device, it becomes possible for the central management suite to receive and store logging information received from different host computing devices in a common data format or structure. It may be also useful for presentation of the logging information in a recognisable data format or structure for analysis or other purposes. In step 1465, the management logging module 266 receives the logs and stores the logs in the storage module 268. The storage module 268 may be implemented as one or more recordable storage devices. The stored firewall logs are then available to be viewed or graphed at a later time, such as by a customer accessing the central management suite via the management portal 262. In one arrangement, the administrator logging in to the management portal 262 is able to retrieve and view firewall logs. In one implementation, the central management suite provides an analysis module to analyse the firewall logs and produce reports and charts derived from the firewall logs. Control passes to an End step 1470 and the method 1400 terminates.

The method 1400 uses a centralised management device to enable centralised administration of host firewall policies, centralised deployment of firewall policies across numerous operating systems, and centralised viewing and graphing of logs generated by the firewalls.

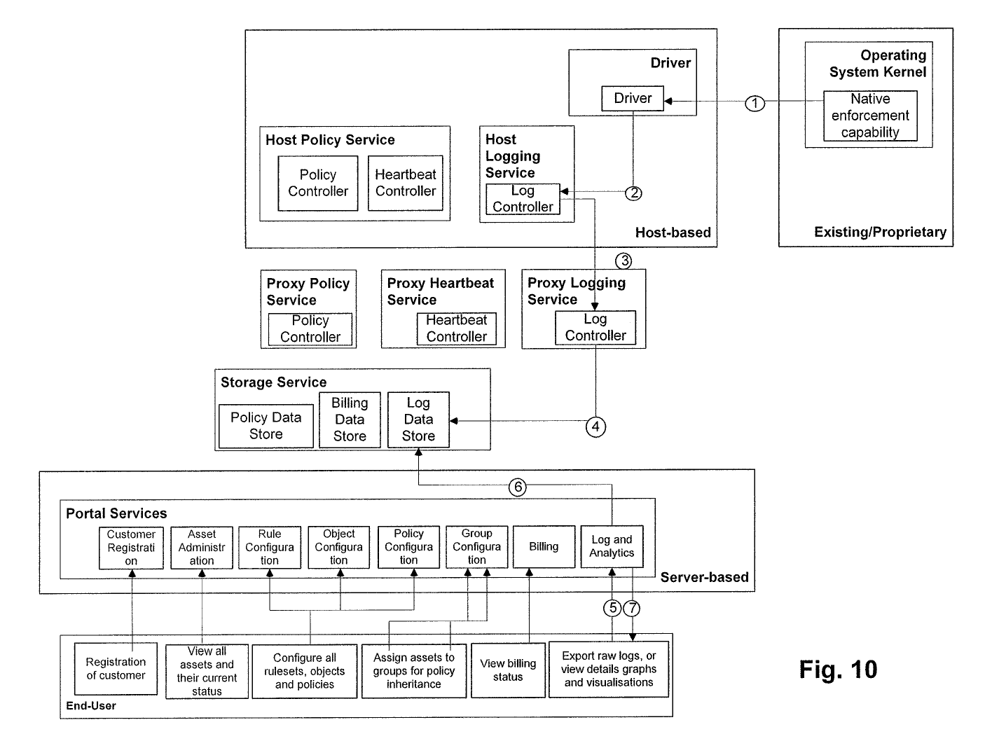

The central management suite 260 and host computing devices 250, 310, 330 of the present disclosure may be practised using a computing device, such as a general purpose computer or computer server. FIG. 12 is a schematic block diagram of a system 1200 that includes a general purpose computer 1210. The general purpose computer 1210 includes a plurality of components, including: a processor 1212, a memory 1214, a storage medium 1216, input/output (I/O) interfaces 1220, and input/output (I/O) ports 1222. Components of the general purpose computer 1210 generally communicate using a bus 1248.

The memory 1214 may include Random Access Memory (RAM), Read Only Memory (ROM), or a combination thereof. The storage medium 1216 may be implemented as one or more of a hard disk drive, a solid state “flash” drive, an optical disk drive, or other storage means. The storage medium 1216 may be utilised to store one or more computer programs, including an operating system, software applications, and data. In one mode of operation, instructions from one or more computer programs stored in the storage medium 1216 are loaded into the memory 1214 via the bus 1248. Instructions loaded into the memory 1214 are then made available via the bus 1248 or other means for execution by the processor 1212 to effect a mode of operation in accordance with the executed instructions.

One or more peripheral devices may be coupled to the general purpose computer 1210 via the I/O ports 1222. In the example of FIG. 12, the general purpose computer 1210 is coupled to each of a speaker 1224, a camera 1226, a display device 1230, an input device 1232, a printer 1234, and an external storage medium 1236. The speaker 1224 may include one or more speakers, such as in a stereo or surround sound system.

The camera 1226 may be a webcam, or other still or video digital camera, and may download and upload information to and from the general purpose computer 1210 via the I/O ports 1222, dependent upon the particular implementation. For example, images recorded by the camera 1226 may be uploaded to the storage medium 1216 of the general purpose computer 1210. Similarly, images stored on the storage medium 1216 may be downloaded to a memory or storage medium of the camera 1226. The camera 1226 may include a lens system, a sensor unit, and a recording medium.

The display device 1230 may be a computer monitor, such as a cathode ray tube screen, plasma screen, or liquid crystal display (LCD) screen. The display 1230 may receive information from the computer 1210 in a conventional manner, wherein the information is presented on the display device 1230 for viewing by a user. The display device 1230 may optionally be implemented using a touch screen, such as a capacitive touch screen, to enable a user to provide input to the general purpose computer 1210.

The input device 1232 may be a keyboard, a mouse, or both, for receiving input from a user. The external storage medium may be an external hard disk drive (HDD), an optical drive, a floppy disk drive, or a flash drive.

The I/O interfaces 1220 facilitate the exchange of information between the general purpose computing device 1210 and other computing devices. The I/O interfaces may be implemented using an internal or external modem, an Ethernet connection, or the like, to enable coupling to a transmission medium. In the example of FIG. 12, the I/O interfaces 1222 are coupled to a communications network 1238 and directly to a computing device 1242. The computing device 1242 is shown as a personal computer, but may be equally be practised using a smartphone, laptop, or a tablet device. Direct communication between the general purpose computer 1210 and the computing device 1242 may be effected using a wireless or wired transmission link.

The communications network 1238 may be implemented using one or more wired or wireless transmission links and may include, for example, a dedicated communications link, a local area network (LAN), a wide area network (WAN), the Internet, a telecommunications network, or any combination thereof. A telecommunications network may include, but is not limited to, a telephony network, such as a Public Switch Telephony Network (PSTN), a mobile telephone cellular network, a short message service (SMS) network, or any combination thereof. The general purpose computer 1210 is able to communicate via the communications network 1238 to other computing devices connected to the communications network 1238, such as the mobile telephone handset 1244, the touchscreen smartphone 1246, the personal computer 1240, and the computing device 1242.

The general purpose computer 1210 may be utilised to implement a server acting as a management portal or host computing device in accordance with the present disclosure. In such an embodiment, the memory 1214 and storage 1216 are utilised to store data relating to registered customers, assets, policies, rules, administration, logs, and the like. Software for implementing the management portal or host computing device is stored in one or both of the memory 1214 and storage 1216 for execution on the processor 1212. The software includes computer program code for effecting method steps in accordance with the method described herein for creating and managing firewall policies.

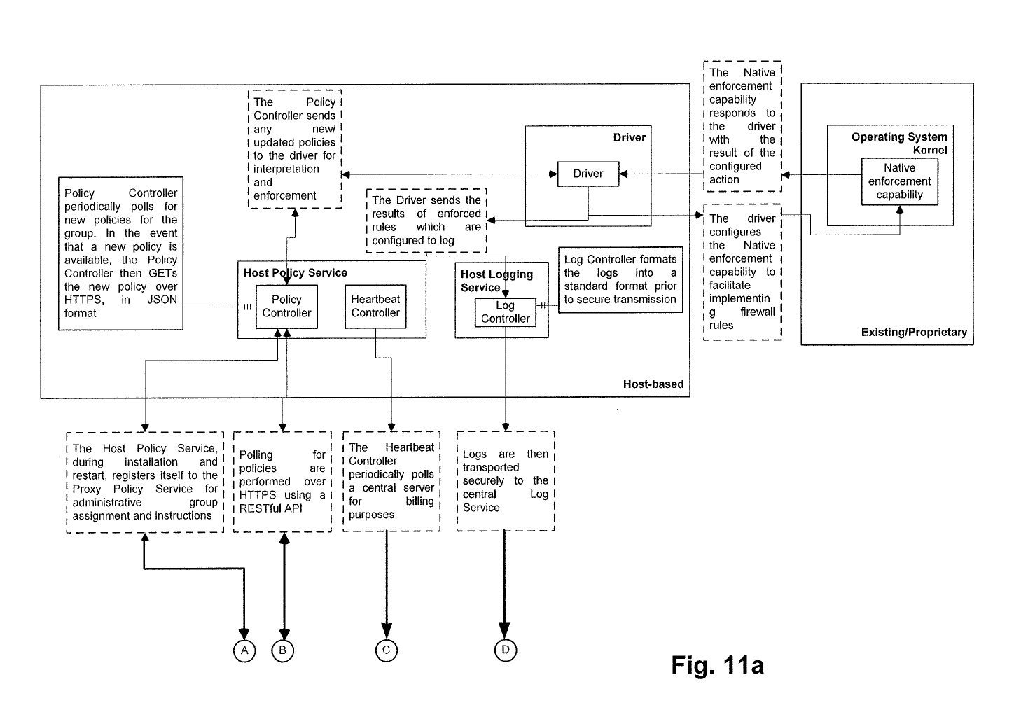

FIG. 13 is a schematic representation of a system 1300 on which embodiments of the present disclosure may be practised. The system 1300 includes a central management suite 1360 hosted on a server 1340. The server 1340 may be implemented using one or more general purpose computing devices, such as the computing device 1210 of FIG. 12, and associated internal or external storage media.

The central management suite 1360 includes a management portal 1362, storage module 1368 hosted on a database, a policy module 1364, and a logging module 1366. The central management suite 1360 also includes an optional analytics module 1369 for processing logs and producing graphical or visual representations of those logs.

The storage module 1368 includes a customer database for storing details associated with customers that register with the management portal 1360. The customer database includes a profile for each customer, wherein each profile includes information relating to that customer. The profile may include, for example, customer identifier, name, address, company number, and billing details.

The server 1340 hosting the central management suite 1360 is connected to a communications network 1305. The communications network 1305 may include, for example, one or more wired or wireless connections, including a Local Area Network (LAN), Wide Area Network (WAN), a virtual private network (VPN), cellular telephony network, the Internet, or any combination thereof.

The system 1300 also includes a computing device 1370 coupled to the communications network 1305. The computing device 1370 may be implemented using a smartphone, laptop, desktop computer, server, or general purpose computer, such as the general purpose computer 1210 of FIG. 12. The computing device 1370 in the example of FIG. 13 is coupled to a printer 1372, a camera 1374, and a database 1376.

In the example of FIG. 13, an administrator associated with a customer utilises the computing device 1370 to establish communication over the communications network 1305 with the central management suite 1360 hosted by the server 1340. The administrator is then able to register the customer, group assets, define rules, create firewall policies, modify firewall policies, and apply firewall policies.

Registration of the customer may require the administrator to provide contact and billing details in exchange for the central management suite 1360 allocating a customer identifier and customer password to access the central management suite.

The system 1300 also includes first and second host computing devices 1310 and 1330 associated with the customer. The first and second host computing devices 1310, 1330 are each connected to the communications network 1305, wherein each of the computing devices 1310, 1330 includes a firewall and an operating system. In the example of FIG. 13, each of the first and second host computing devices 1310, 1330 has an installed driver for communicating with the firewall of the respective host computing device. Each of the first and second host computing devices 1310, 1330 also has an installed host policy module and host logging module that communicate with the policy module 1364 and logging module 1366 of the central management suite 1360, via the communications network 1305. Each of the computing devices 1310, 1330 is implemented using an instance of the general purpose computing device 1210 of FIG. 12.

An authorised administrator of a customer utilises the computing device 1370 to log in to the management portal 1362 of the central management suite 1360. The management portal 1362 then provides a graphical user interface for display on a display device of the computing device 1370 accessed by the administrator. The administrator uses the interface to navigate menus provided by the management portal 1362 relating to management of the firewalls of the first and second host computing devices 1310, 1330. The customer uses an input device, such as a mouse, touchscreen, keyboard, stylus, or the like to select options and provide input to create, manage, and modify rules, groups, and policies relating to the firewalls of the first and second host computing devices 1310, 1330. Following receipt of the input provided by the administrator, the central management suite 1360 transmits policies to host policy modules installed on the first and second host computing devices 1310, 1330, whereupon the host policy modules pass the transmitted policies to the respective drivers to configure the firewall. In one implementation, the policy module 1364 pushes policies out to the host policy modules installed on the first and second host computing devices 1310, 1330. In another implementation, the host policy modules of the host computing devices 1310, 1330 poll the management policy module 1364 at periodic intervals for policies that affect the relevant host computing device and the management policy module 1364 transmits the policies in response to the polling.

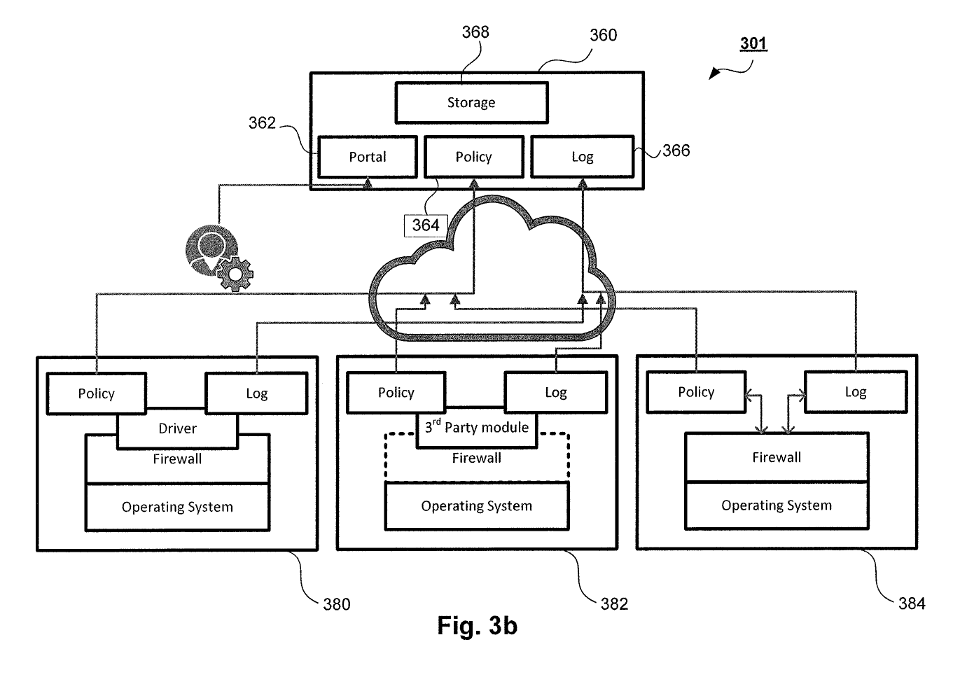

FIG. 5 is a schematic block diagram representation illustrating a customer registration process. An end user 275, such as an administrator authorised to perform functions on behalf of the user, utilises a computing device 270 to communicate, via a communications link, with the management portal 262 of the central management suite 260. In one arrangement, the management portal 262 provides a website with one or more web pages to be displayed on the computing device 270.

The user browses and navigates the management portal 262 and initiates registration of a new customer with the central management suite 260. The central management suite 260 receives a request for registration of the customer and generates a customer identifier uniquely associated with that customer. The management portal 262 communicates with the storage module 268 to create a policy data store, a billing data store, and a logging data store associated with that customer.

In one arrangement, each of the policy data store, billing data store, and logging data store form part of a customer profile. Such a customer profile may include other information relating to the customer, such as name, business number, contact details, accounting details, customer identifier, customer password, and the like.

The user portal 262 then returns the assigned customer identifier and associated customer password to the registering customer.

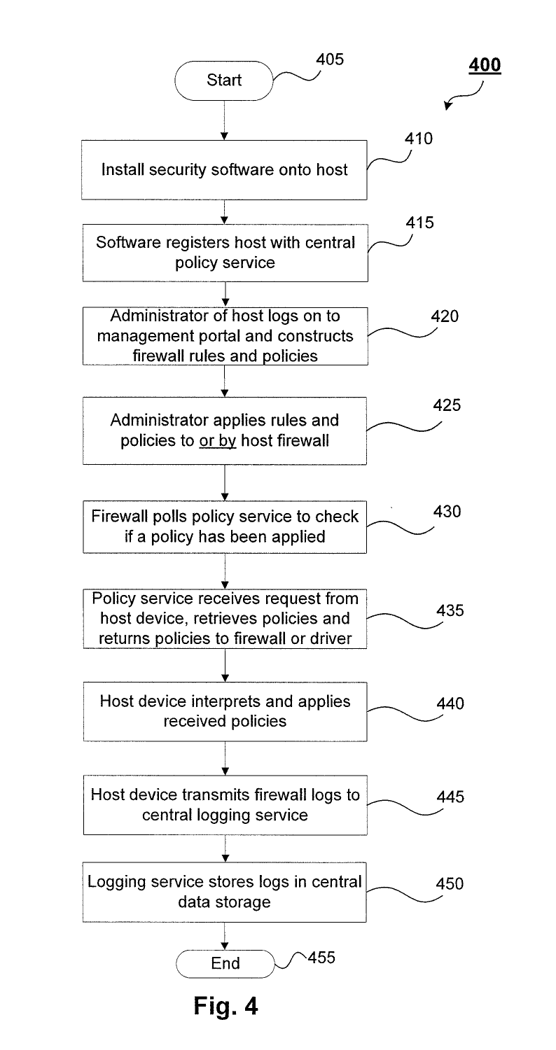

FIG. 6 is a schematic block diagram representation illustrating registration of a host computing device, or asset. In this example, an asset is a computing device running a Windows operating system of Server 2003 or newer or a computing device running a Linux operating system with Kernel 3.5 or newer for Ubuntu, Redhat, or Fedora. No pre-defined policy, group, or rules are required for an asset to be registered.

In one arrangement, an administrator of a registered customer utilises the computing device 270 to communicate with the user portal 262 of the management portal 260 and download an installation package to be installed on an asset. Depending on the implementation, the management portal 260 offers one or more installation packages, suitable for use on host computing devices with different operating systems.

The administrator then installs the installation package on the asset. FIG. 6 is a schematic representation of installation of the installation package on an asset. In a first step, the user installs the installation package on the asset and is prompted by the installation package to provide the customer identifier, IP address of the management policy module 264 (policy proxy service), IP address of the management logging module 266 (logging proxy service), and IP address of a heartbeat proxy service. The heartbeat proxy service is an optional functional module that provides a heartbeat between the host computing device 250 and the central management suite 260. The heartbeat proxy service may be used, for example, to determine an active or inactive state of a host computing device, for billing purposes, and the like. In one arrangement, the host policy module 220 performs the heartbeat functionality for the host computing device 250. In an alternative arrangement, a dedicated host heartbeat module is implemented on the host computing device 250 to perform heartbeat functionality.

Similarly, in one arrangement the management policy module 264 performs the heartbeat functionality for the central management suite. In an alternative arrangement, a dedicated management heartbeat module is implemented on the central management suite 260.

Depending on the implementation, the administrator enters the required information on the individual asset or using a central management platform coupled to the relevant asset. The installation package receives the information, validates the customer identifier, and then installs the following elements on the asset:
1) host policy service (module);
2) host logging service (module);
3) host heartbeat service (module); and
4) driver.

The driver activates and integrates with the native enforcement capability, which, as described above, is the localised method of providing a firewall for the operating system platform executing on the asset.

The host policy module 220 transmits a policy message to the management policy module 264 and registers the asset with the management policy module 264 using the customer identifier. The policy message includes information relating to the asset, including, for example, IP address of the asset, operating system of the asset, version, date, time, and the like. The management policy module 264 enters parsed information derived from the policy message to be stored in the management storage module 268.

The host policy module 220 requests from the management policy module 264 group information relating to any relevant group to which the asset is associated. Such group information may include, for example, a customer policy defining a firewall policy to be applied to all assets classified into that group. The management policy module 264 returns relevant policy information to the host policy module 220, wherein the relevant policy information may be null or a predefined policy that is to be applied to the asset. The host policy module 220 then parses the relevant policy information and presents the parsed policy information to the driver 215. The driver interprets the parsed policy information and applies it to the native enforcement capability.

The host computing device may be configured to implement firewall rules based on information extracted from the relevant packet. This information may include header information any one or more of the Network layer (layer 3) header, Transport layer (layer 4) header, Session layer (layer 5) header, Presentation layer (layer 6) header and/or Application layer (layer 7) header. The following description focusses on layer 4 (stateful inspection) and layer 7 (application inspection) firewalling, but is generally applicable to firewalling based on other layer or layers.

One method of firewalling uses specific criteria found in, and below, Layer 4 of the OSI model. In one implementation, firewalling controls flow of data based on a source or destination address(es) being used, and/or the destination ports. For example, port 80 is typically used for HTTP (web browsing). Thus, a firewall can be configured to block any source address from hitting a specified web site at IP address 1.1.1.1 on port 80.

In one instance, the hosting computing device may be configured to implement application-layer-based firewalling. Application Definition is the ability to perform enforcement based on criteria relating to the Application layer (i.e. layer 7) of the OSI model. For example, a user wants to block anyone from hitting a webpage www.someexample.com/private and allow anyone to hit a webpage www.someexample.com/public. Both of these connections use the same criteria found in the example relating to IP address 1.1.1.1 and port 80. However, Application Definition allows a user to configure a firewall with greater resolution or granularity. For example, the driver configures the firewall to allow or deny and/or log data packets requested by or destined for a particular application running on the host computing device.

In another instance, the hosting computing device may be configured to implement transport-layer-based firewalling. Application Awareness is the ability to know what a protocol should look like on the network, being able to detect what protocol is being used and then performing actions once identified.

Following on from the example; the typical port for HTTP is TCP port 80. Application Awareness allows for an asset/host firewall to detect that the protocol being used on TCP port 80 is in fact HTTP. Furthermore, using pre-defined criteria (such as RFC compliance, for example), the asset/host firewall can ensure compliance with the protocol. Identifying protocols and enforcing compliance is useful in preventing attackers from trying to manipulate the use of the HTTP protocol in order to hide communications.

A further example of Application Awareness is the ability to enforce a rule based on protocol, regardless of port. For example, a user wants to block FTP traffic, allow HTTP traffic, enforce strict RFC compliance, allow SMTP traffic (email), but not allow attachments on emails. Using Application Awareness, no IP addresses or ports are identified. Rather, the Application Awareness of the native enforcement capability determines the protocols being used and performs any defined actions.

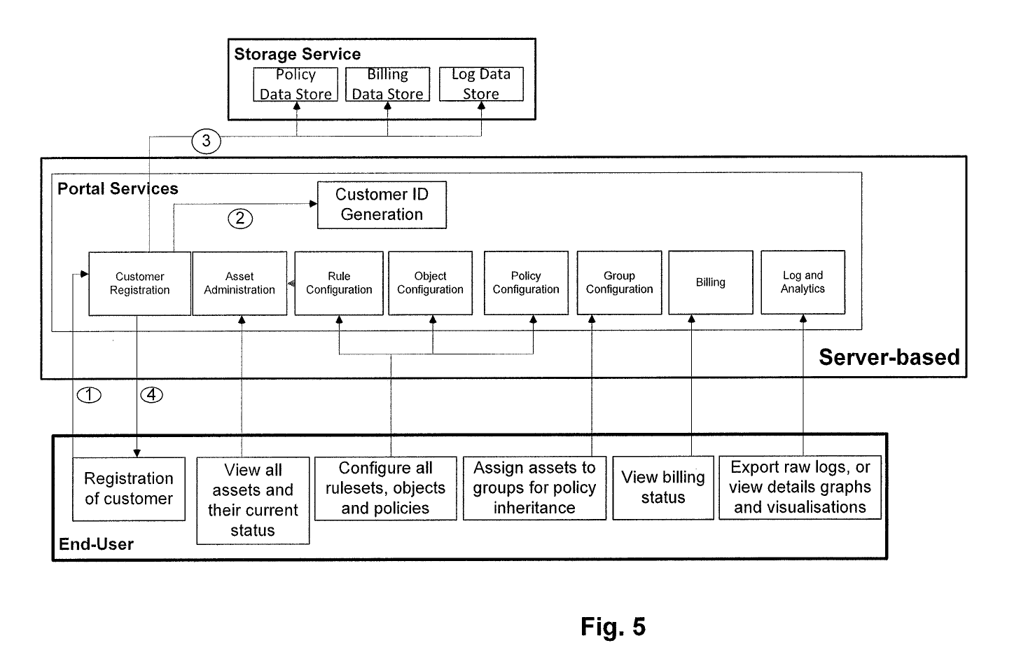

FIG. 7 is a schematic block diagram representation illustrating definition of objects, rules, and policies for use in a firewall of a computing system. A rule is implemented using a combination of source objects, destination objects, service objects, and application awareness. In this example, a rule also specifies whether to create a Log entry, Yes or No, and whether to take an Action, Allow or Deny.

An Application Definition is one of:
1) identification of a protocol;
2) type of anomaly or standardisation of a protocol (i.e., RFC compliance); and
3) control of matching flows.

A policy is a set of one or more rules, wherein an ordering of rules within the set affects a flow of traffic allowed or blocked to an asset.

A group of assets can be associated with one or more policies. In the case in which multiple policies are assigned to a group, the ordering of the policies determines the order in which the policies are applied.

Referring to FIG. 7, a user 275 utilises a computing device 270 to communicate with the management portal 262 of the central management suite 260. The management portal 262 provides an interface that allows the user to define objects, rules, and policies. In an initial step, the user defines one or more objects to be used for rules. The user-defined objects may include, for example, network objects for use as sources or destinations, service objects for use as services, application definitions, and application signatures and controls. The user is able to select the user-defined objects to be combined into: (i) one or more network object groups for use as sources or destinations; or (ii) one or more service object groups for use as services.

Application definitions and signatures allow for: (i) application controls, regardless of direction; and (ii) application identification for anomaly detection.

All objects defined by the user are stored by the central management suite 260 in the policy data store associated with the customer for which the user is an authorised administrator. The user is then able to create one or more rules from the defined objects. The central management suite 260 stores the created rules in the policy data store associated with that customer. Having defined one or more rules, the user is able to create one or more policies, wherein each policy is a set of one or more of the defined rules. The central management suite 262 stores the policies in the policy data store associated with that customer. The policy data store associated with each customer is stored in the storage module 268 of the central management suite 260.

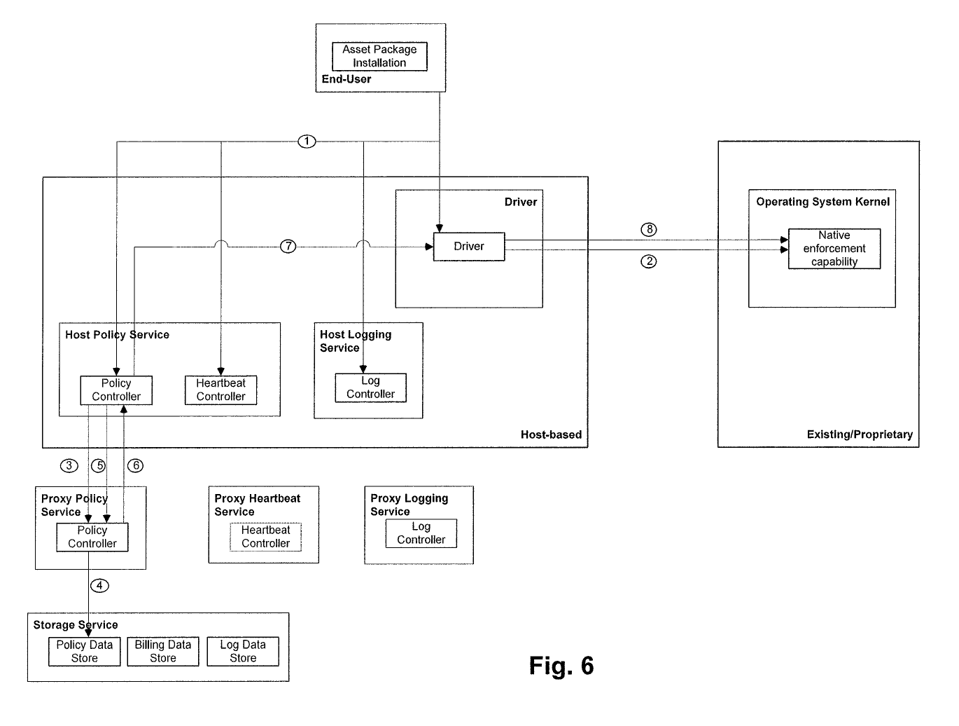

FIG. 8 is a schematic block diagram representation illustrating definition of groups and related associations. A group is an association of multiple assets with related attributes, such that the assets fulfil similar purposes or are associated with the same policies. Grouping assets with related attributes allows a customer to apply, deploy, and manage standardised policies to assets within a group. An asset is uniquely assigned to a group. This prevents an asset from belonging to multiple groups, which could result in different, conflicting policies being applied to the asset. Multiple policies can be assigned to a group.

An administrator 275 uses a computing device 270 to communicate with the management portal 262 of the central management suite 260. The administrator creates a new group and assigns one or more policies to that group. The management portal 262 writes a group-to-policy association to the policy store data in the storage module 268. The administrator associates one or more assets to the group. This may include re-assigning an asset from another existing group. The management portal 262 then writes an asset-to-group association to the policy store data in the storage module 268.

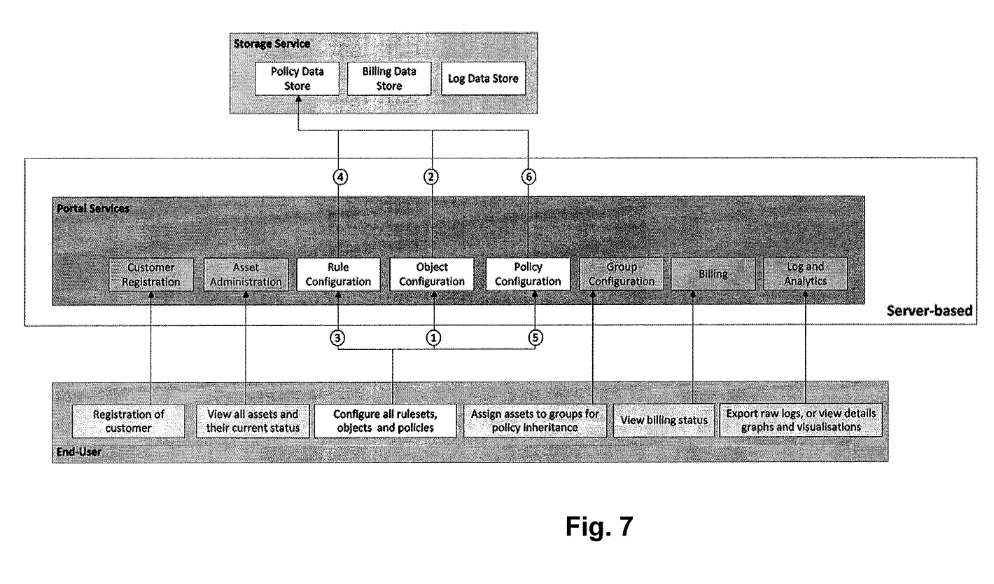

FIG. 9 is a schematic block diagram representation illustrating asset polling and association. As described above, an asset that has not been classified into a group is in an “unassociated” state and has no firewall policy to enforce. Once the driver, host policy module, and host logging module have been installed on an asset, the asset polls the policy proxy service at a predefined periodic interval, such as every 60 seconds, to check whether the asset has been associated with a group. Whilst the asset remains unassociated, no policies are passed from the central management suite to the asset. Further, the asset does not perform any logging and no heartbeats are performed. Bounds checking is performed to ensure that an asset cannot request policies and rules for a group with which the asset is not associated.

The host policy module 220 periodically polls the management policy module 264 of the central management suite 260 to identify any asset association defined by a customer in relation to the asset (host computing device) 250. The management policy module 264 checks the storage module 268 for any association relating to the asset 250 and returns the result to the management policy module 264, which in turn passes the result to the host policy module 220. The returned result is either a name of a group with which the asset is associated or a null result. If the returned result is the name of a group, the host policy module 220 then requests any policies associated with that group. The management policy module 264 polls the storage module 268 for any policies, rules, and objects associated with the group.

The storage module 268 returns the policies, rules, and objects associated with the group to the management policy module 264, which in turn passes the returned policies, rules, and objects to the host policy module 220. The host policy module 220 passes the returned policies, rules, and objects to the driver 215. The driver 215 translates the received policies, rules, and objects for application by the respective native enforcement capability and applies the relevant controls and logging requirements.

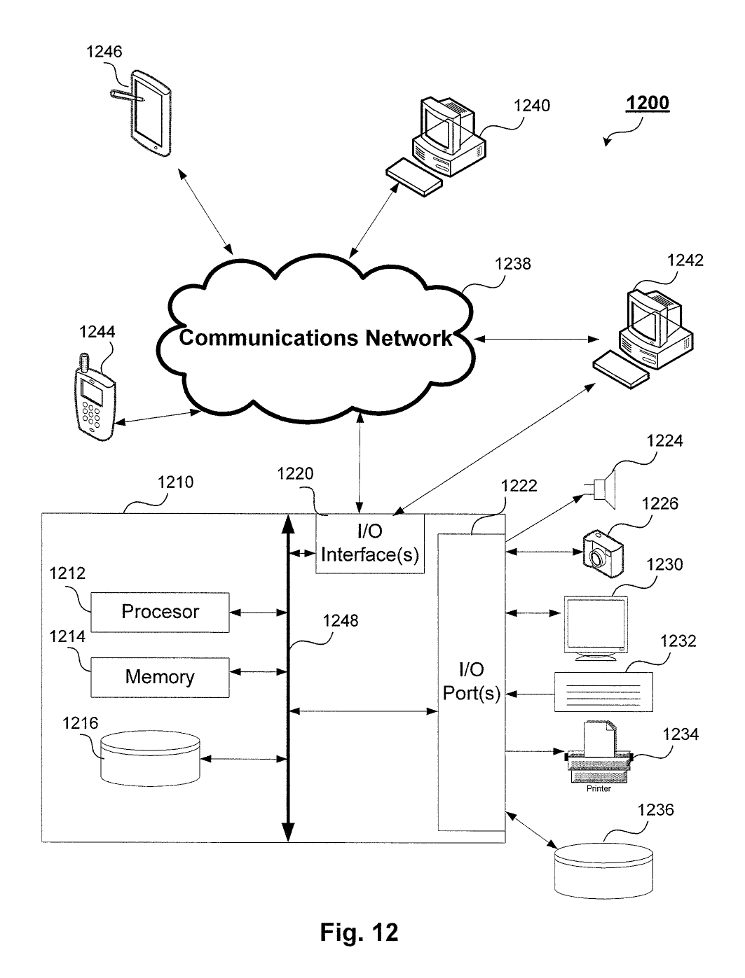

FIG. 15 is a schematic representation of a rules interface 1500 presented by the management portal 262 to a display of the computing device 270 accessed by an administrator to create and modify rules relating to the firewall 205 of the host computing device 250. In this example, the rules interface shows five defined rules: web; Deny all TCP; udp; icmp_deny_all; and Allow_All_Traffic. Each rule is associated with a set of controls that enable the administrator to activate, deactivate, or edit the rule in question.

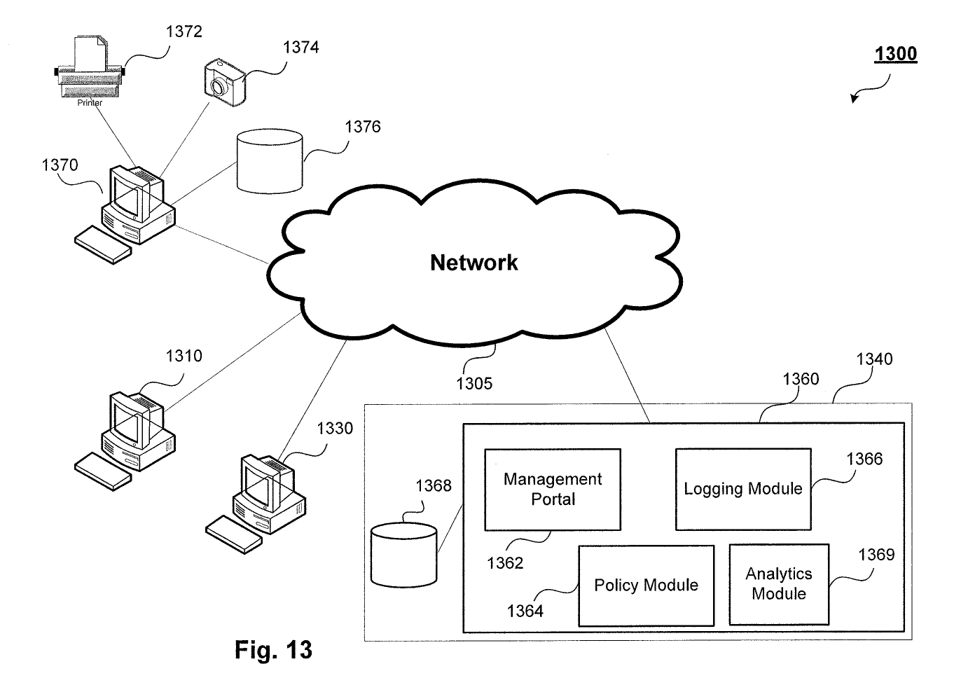

FIG. 16 is a screenshot of a policies interface 1600 presented by the management portal 262 to a display of the computing device 270 accessed by an administrator to create and modify policies relating to the firewall 205 of the host computing device 250. In this example, the policies interface shows three defined policies: telnet_policy; web_policy; and All_traffic_policy. Each policy is associated with a set of controls that enable the administrator to activate, deactivate, or edit the policy in question.

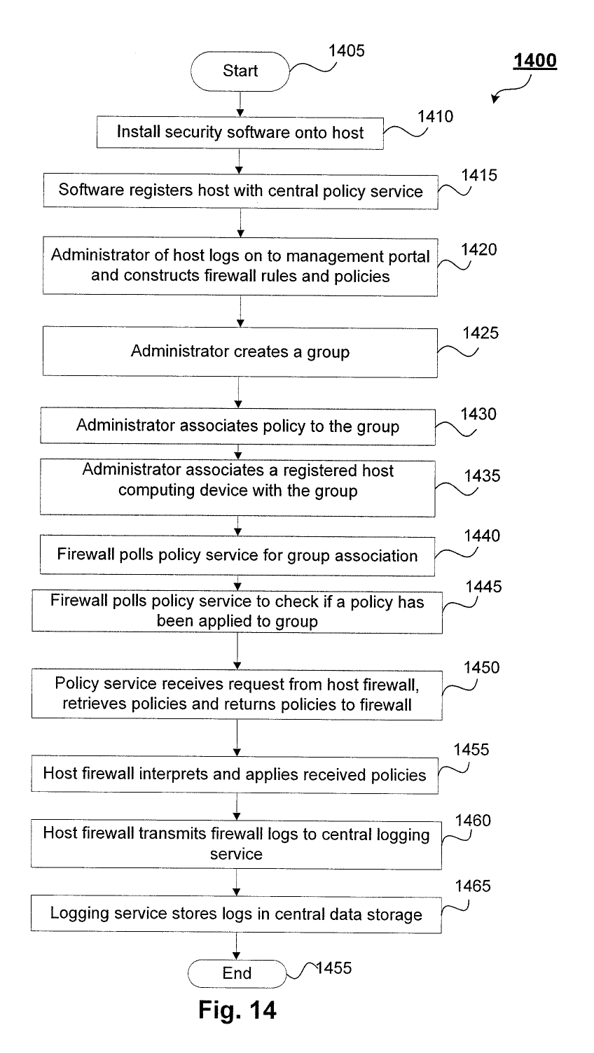

FIG. 17 is a schematic representation of a groups interface 1700 presented by the management portal 262 to a display of the computing device 270 accessed by an administrator to create and modify groups of host computing devices to which policies are to be applied. In this example, the groups interface shows five defined groups: web_servers; unallocated; Allow_All_Traffic_Group; test_group; and telnet_servers. Each group is associated with a set of controls that enable the administrator to activate, deactivate, or edit the group in question. The administrator is able to add or delete a host computing device from a group.

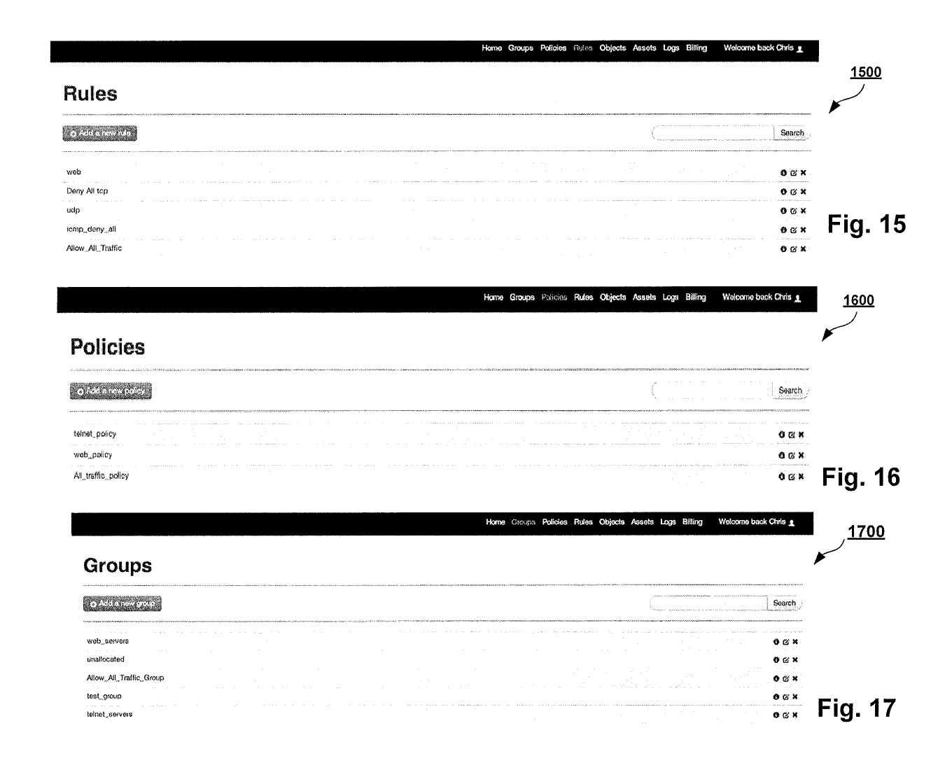

FIG. 18a is a schematic representation of a rule editing interface 1800 presented by the management portal 262 to a display of the computing device 270 accessed by an administrator to edit an existing rule. In this example, the rule being edited is the “Allow_All_Traffic” rule. In this particular arrangement, the rule editing interface 1800 allows the administrator to select an action, such as permit or restrict, and activate or deactivate logging for various flows of data. In particular, the administrator is able to select one or more sources, destinations and services to be controlled by this rule.

In this example, the administrator selects “permit” as the action and sets logging to false. The administrator selects one or more sources from the list of sources, which in this example includes: web servers, external, localhost, tester_network, and internal network.

FIG. 18b shows the rule editing interface 1800, with the administrator selecting a service, which in this example includes: ftp, web, telnet, HTTPS, and icmp.

FIG. 18c shows the rule editing interface 1800, with the administrator selecting a destination from the list of destinations, which in this example includes: web servers, external, localhost, tester_network, and internal network.

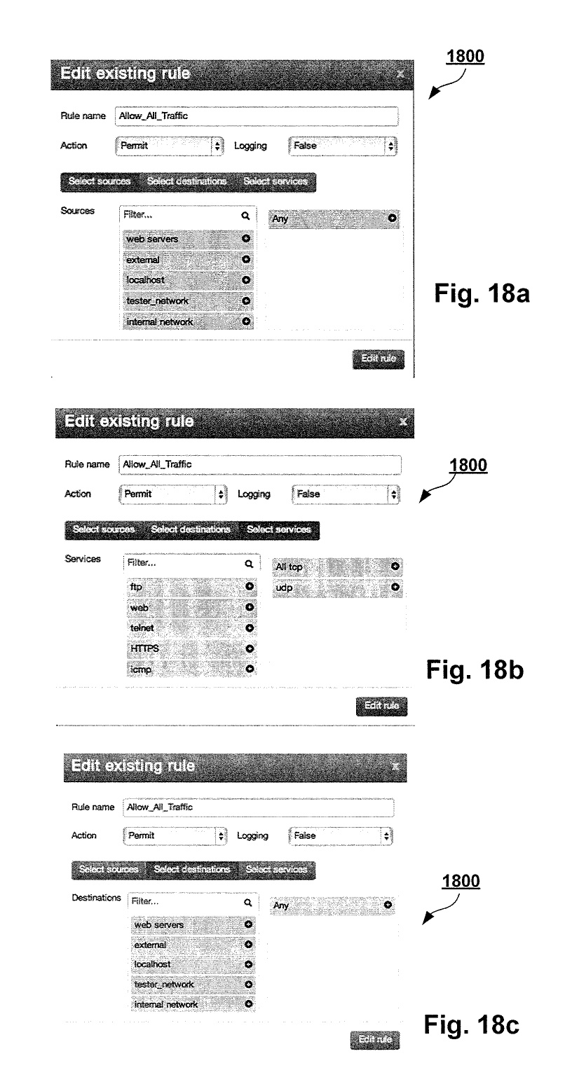

FIG. 19 is a screenshot of a policy editing interface 1900 presented by the management portal 262 to a display of the computing device 270 accessed by an administrator to edit an existing rule. In this example, the policy being edited is the policy entitled “All_traffic_policy”. In this particular arrangement, the policy editing interface 1900 allows the administrator to select a set of rules to make a policy.

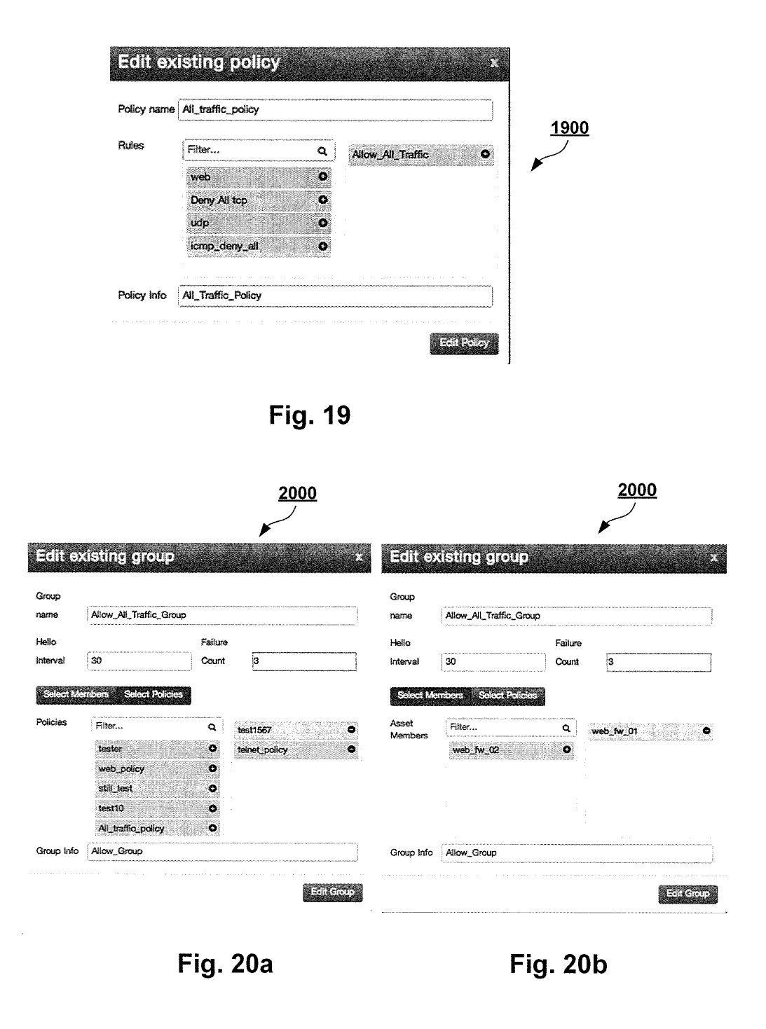

FIG. 20a is a schematic representation of a group editing interface 2000 presented by the management portal 262 to a display of the computing device 270 accessed by an administrator to edit an existing rule. In this example, the group being edited is the group entitled “Allow_All_Traffic_Group”. In this particular arrangement, the group editing interface 2000 allows the administrator to define a “Hello Interval” and a “Failure Count”. The Hello Interval defines a periodic interval during which a host computing device must poll the management policy module of the central management suite for new policies or modifications to existing policies affecting that host computing device. The Failure Count is an internal count maintained by the central management suite for monitoring policy checks and heartbeats from host computing devices registered with the central management suite.

The administrator is able to create and modify a group by selecting group members from a set of registered host computing devices and selecting one or more policies from a set of defined policies. In this example, the administrator has selected the policies “test1567” and “telnet_policy”.

FIG. 20b shows the group editing interface 2000, with the administrator selecting web_fw_01 as a group member. A set of registered asset members (host computing devices) available to be added to the group includes the host computing device we b_fw_02.

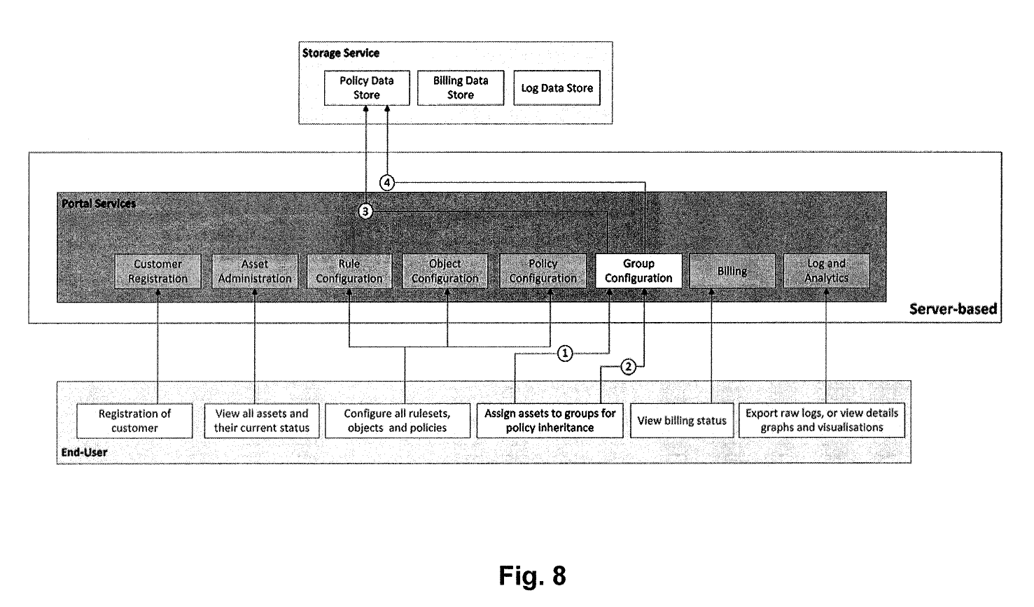

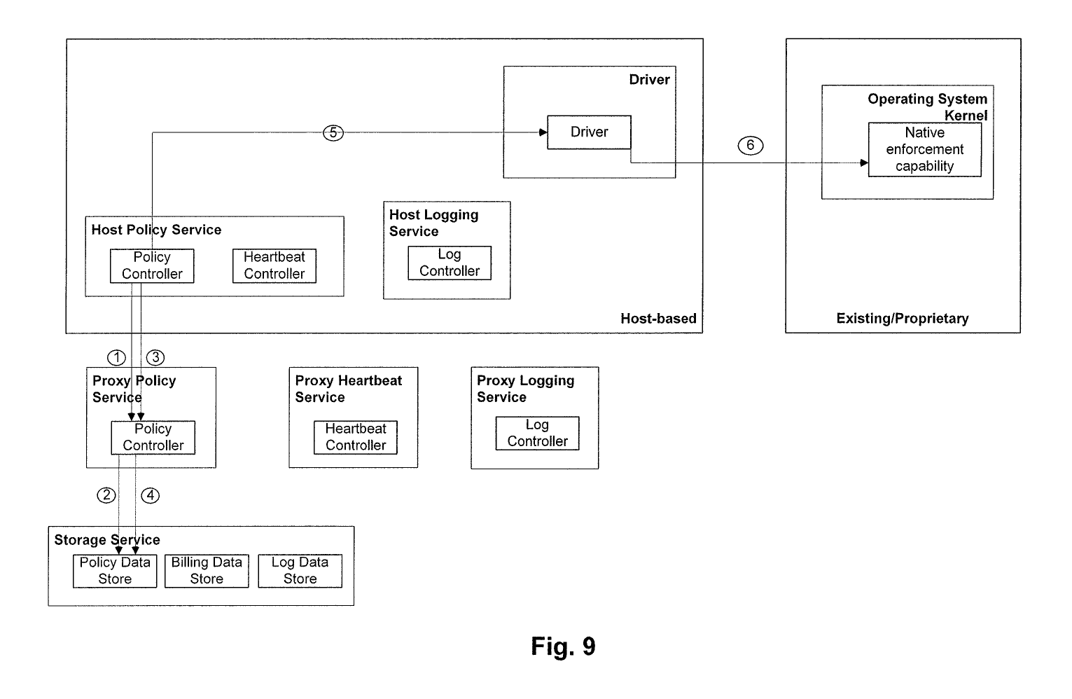

FIG. 10 is a schematic block diagram representation illustrating logging performed in relation to a host computing device with an installed driver 215, host policy module 220, and host logging module 225. In this example, the default setting for a rule is not to log when definitions are met.

The native enforcement capability implementing the firewall of a host computing device matches a predefined rule and flags the rule to the driver 215, along with any relevant information. Such relevant information may include, for example, source IP address, destination IP address, service, time, action, and the like.

If the matched rule has been configured to log, then the driver 215 transmits the information received from the native enforcement capability to the host logging module 225, which in turn passes the information to the management logging module 266 of the management portal 260. The management logging module 266 stores the information in the storage service log data store associated with the customer, in the storage module 268.

One arrangement implements a set of management firewall rules that cannot be configured by an administrator. The set of management firewall rules enables management traffic between the central management suite 260 and the host computing device 250 to be permitted above any administrator-defined rule. The set of management firewall rules ensures that each host computing device 250 has management connectivity to the central management suite 260. In one arrangement, only rules defined by an administrator generate logs.

The administrator associated with that customer is subsequently able to log in to the management portal 262 of the central management suite 260 to request logs from the storage module 268 relating to a specific group, asset, service, policy, or rule. The management portal 262 retrieves the requested logs from the storage module 268 and presents the retrieved logs to a computing device 270 utilised by the administrator. Depending on the application, the management portal 262 presents the logs as raw data available for download, graphical data, visualised data, or data formatted in a predefined way.

### INDUSTRIAL APPLICABILITY

The arrangements described are applicable to the computer and data processing industries.

The foregoing describes only some embodiments of the present invention, and modifications and/or changes can be made thereto without departing from the scope and spirit of the invention, the embodiments being illustrative and not restrictive.

In the context of this specification, the word “comprising” and its associated grammatical constructions mean “including principally but not necessarily solely” or “having” or “including”, and not “consisting only of”. Variations of the word “comprising”, such as “comprise” and “comprises” have correspondingly varied meanings.

As used throughout this specification, unless otherwise specified, the use of ordinal adjectives “first”, “second”, “third”, “fourth”, etc., to describe common or related objects, indicates that reference is being made to different instances of those common or related objects, and is not intended to imply that the objects so described must be provided or positioned in a given order or sequence, either temporally, spatially, in ranking, or in any other manner.

Although the invention has been described with reference to specific examples, it will be appreciated by those skilled in the art that the invention may be embodied in many other forms.

1. A system for managing a firewall of one or more end-host computing devices associated with a customer, each end-host computing device including a configurable firewall, said system including:
a central management suite coupled to a first end-host computing device via a communications link, said central management suite including:
a management portal for receiving instructions from said customer relating to a set of policies, wherein each policy defines a set of firewall rules;
a storage device for storing said set of policies in a format inapplicable for configuring the firewall of the first end-host computing device; and
a management policy module for retrieving from said stored set of policies a policy associated with said first end-host computing device; and
a first policy translator resident on said first end-host computing device for receiving said retrieved policy from said central management suite, via said communications link, and for translating said retrieved policy to a format applicable for configuring the firewall of the first end-host computing device to facilitate implementing a set of firewall rules defined by said retrieved policy.

2. The system according to claim 1, further including a second policy translator resident on a second end-host computing device associated with said customer and the retrieved policy, the set of policies also being in a format inapplicable for configuring a configurable firewall of the second end-host computing device, the second policy translator adapted for receiving the retrieved policy from the central management suite, via the communications link, and translating the retrieved policy to a format applicable for configuring the firewall of the second end-host computing device to facilitate implementing the set of firewall rules defined by said retrieved policy.

3. The system according to claim 2, wherein the first policy translator and the second policy translator are specific to the operating system of the first end-host computing device and the operating system of the second end-host computing device, respectively.

4. (canceled)

5. The system according to claim 2, wherein the first or the second policy translator includes a driver for said translating and for communicating with at least one application programming interface of the kernel of the operating system of the respective end-host computing device.

6. The system according to claim 2, wherein the first or the second policy translator includes an end-host policy module for receiving said retrieved policy from said management policy module, via said communications link, and adapted for said translating and for communicating the translated policy to an application module which is adapted to configure the firewall of the respective end-host computing device.

7. The system according to claim 6, wherein the application module is selected from a group consisting of a web application firewall, an email server security enforcement module, or an anti-virus controller.

8. The system according to claim 4, wherein either or both of the first and the second policy translators includes an end-host policy module for receiving said retrieved policy from said management policy module, via said communications link, and adapted for said translating and for communicating the translated policy to a native component which is native to the operating system and adapted to configure the firewall of the respective end-host computing device.

9. The system according to system according to claim 1, wherein the firewall is configured to determine an appropriate action for one or more data packets.

10. (canceled)

11. (canceled)

12. (canceled)

13. (canceled)

14. (canceled)

15. (canceled)

16. The system according to claim 1, further including:
a first end-host logging module resident on said first end-host computing device, said first end-host logging module adapted to record logging information including firewall decisions made on incoming or outgoing traffic relating to said first end-host computing device in accordance with said retrieved policy.

17. The system according to claim 16, wherein the first end-host logging module is further adapted to translate the logging information in a first data format or structure into logging information in a second data format or structure.

18. The system according to claim 16, further including a second end-host logging module resident on said second end-host computing device, said second end-host logging module adapted to record logging information relating to said second end-host computing device in accordance with said retrieved policy, the second end-host logging module further adapted to translate logging information in a third data format or structure into logging information in the second data format or structure.

19. (canceled)

20. The system according to claim 16, wherein said central management suite further includes a management logging module for receiving said logging information from said either or both of the first and the second end-host logging modules and storing said logging information in said storage device.

21. (canceled)

22. A method for managing a firewall of one or more end-host computing devices associated with a customer, said method including the steps of:
installing a first policy translator on a first end-host computing device including a first configurable firewall, said first policy translator being adapted to translate a firewall policy in a format inapplicable for configuring the first firewall to a format applicable for configuring the first firewall;
registering said first end-host computing device with a central management suite, said central management suite including a management portal, a management policy module, and a storage device;
defining a set of policies, each policy in said set of policies defining a set of firewall rules;
assigning a first policy from said set of policies to said first end-host computing device; and
transmitting said first policy from said central management suite to said first policy translator to thereby configure the first firewall to facilitate implementing the set of firewall rules defined by said first policy.

23. The method according to claim 22, including the further steps of:
installing a second policy translator on a second end-host computing device including a second configurable firewall, said second policy translator being adapted to translate a firewall policy in a format inapplicable for configuring the second firewall to a format applicable for configuring the second firewall;
registering said second end-host computing device with a central management suite;
associating said first end-host computing device and said second end-host computing device with a group of registered end-host computing devices;
assigning a group policy from said set of policies to said group of registered end-host computing devices;
transmitting said group policy from said central management suite to said second policy translator to thereby configure the second firewall to facilitate implementing the set of firewall rules defined by said first policy.

24. The method according to claim 22 or 23, including the further steps of:
installing a first end-host logging module on said first end-host computing device; said first end-host logging module logging events as logging information relating to said first firewall, based on said first policy.

25. The method according to claim 24, including the further step of translating the logging information relating to the first firewall in a first data format or structure into logging information in a second data format or structure.

26. (canceled)

27. (canceled)

28. (canceled)

29. The method according to claim 23, wherein said group policy is said first policy.

30. (canceled)

31. (Canceled)

32. (Canceled)

33. A central management suite for managing a firewall of one or more end-host computing devices associated with a customer, said central management suite coupled to a first end-host computing device including a first configurable firewall via a communications link, said central management suite including:
a management portal for receiving instructions from said customer relating to a set of policies, wherein each policy defines a set of firewall rules;
a storage device for storing said set of policies in a format inapplicable for configuring the first firewall of the first end-host computing device; and
a management policy module for retrieving from said stored set of policies a policy associated with said first end-host computing device,
wherein said first end-host computing device includes a first policy translator for receiving said retrieved policy from said central management suite, via said communications link, and for translating said retrieved policy to a format applicable for configuring the first firewall of the first end-host computing device to facilitate implementing a set of firewall rules defined by said retrieved policy.

34. The central management suite according to claim 33 coupled to a second end-host computing device including a second configurable firewall via a communications link,
wherein said set of policies is associated with said first end-host computing device and is in a format inapplicable for configuring the second firewall of the second end-host computing device; and
wherein said second end-host computing device includes a second policy translator for receiving said retrieved policy from said central management suite, via said communications link, and for translating said retrieved policy to a format applicable for configuring the second firewall of the second end-host computing device to facilitate implementing a set of firewall rules defined by said retrieved policy.

35. The system according to claim 1 wherein said communications link includes a public network.

36. (canceled)

37. (canceled)
